(19) United States
(12) Patent Application Publication
(10) Pub. No.: US 2006/0077601 A1
(43) Pub. Date: Apr. 13, 2006

(54) Semiconductor device

(76) Inventors: Hiroyuki Ikeda, Higashimurayama (JP); Kazuo Tanaka, Hachioji (JP); Hiroyasu Ishizuka, Ome (JP); Koichiro Takakuwa, Tachikawa (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/222,780

(22) Filed: Sep. 12, 2005

(30) Foreign Application Priority Data
Sep. 30, 2004 (JP) 2004-285593

(51) Int. Cl. H02H 9/00

(52) U.S. Cl. 361/56

(57) ABSTRACT

The invention intends to provide a semiconductor device capable of preventing an electrostatic breakdown especially by the CDM, of the electrostatic breakdowns generated between plural power supply systems, with a few number of protection circuits. The semiconductor device includes a first circuit block that operates with a first power supply voltage and a first reference voltage, and a second circuit block that operates with a second power supply voltage and a second reference voltage. Further, the semiconductor device includes a first clamp circuit that clamps a potential between the first power supply voltage and the second reference voltage, a second clamp circuit that clamps a potential between the second power supply voltage and the first reference voltage, and a third clamp circuit that clamps a potential between the first reference voltage and the second reference voltage.

### CROSS REFERENCE TO RELATED APPLICATION

The present application claims priority from Japanese patent application No. 2004-285593 filed on Sep. 30, 2004, the contents of which is hereby incorporated by reference into this application.

### BACKGROUND OF THE INVENTION

The present invention relates to a semiconductor device provided with an ESD (Electro Static Discharge) protection circuit, specifically to a technique effective in use for a semiconductor device provided with the ESD protection circuit that prevents electrostatic breakdowns between inner circuits of a SOC (System On Chip) containing plural inner circuits that operate with different voltages.

According to the examination by the inventors of this application, there are the following techniques for the ESD protection circuit, which are used in a semiconductor device provided with plural operational voltages.

The patent document 1 as one example, in regard to a semiconductor integrated circuit device that exchanges signals between plural inner circuits with different power supply lines, discloses a construction that includes clamp circuits between the power supply line of one inner circuit and the ground line of the other inner circuit, between the ground line of the one inner circuit and the power supply line of the other inner circuit, and between the power supply line and the ground line of each of the inner circuits. The feature of this invention lies in the layout for making up these clamp circuits, that is, the invention effectively utilizes the N-type semiconductor region and P-type semiconductor region in the I/O area located on the periphery of the chip, thereby facilitates forming these clamp circuits.

The patent document 2 as another example, in regard to an LSI having multiple power supply systems, discloses a semiconductor device in which any electrostatic breakdown charges are discharged by protection elements of not more than three stages in series and these protection elements are located in the center of the LSI. That is, the invention reduces the number of the protection elements lying on discharge paths of power supply lines and the like and designs the layout so as to shorten the discharge paths of the power supply lines and the like; thereby, when there occur discharges, it reduces the clamp voltages and the voltages generated by wiring resistances and suppresses the voltages applied to the inner circuits.

The patent document 3 as another example, in regard to a semiconductor device provided with a noise-resistant functional unit and a noise-susceptible functional unit each having different power supply lines, discloses a construction that includes clamp circuits made up with diode connections of MOS transistors between the power supply line of one functional unit and the ground line of the other functional unit, between the ground line of the one functional unit and the power supply line of the other functional unit, between the power supply line of the one functional unit and the power supply line of the other functional unit, and between the ground line of the one functional unit and the ground line of the other functional unit. Thereby, the invention prevents the electrostatic breakdowns generated between different power supply lines and noises generated between different power supply lines.

The patent document 4 as another example discloses a semiconductor integrated circuit device that reduces the number of protection circuits against electrostatic potentials generated between multiple power supply lines on one chip, and that restricts the area of the chip from expanding. That is, the invention provides a common bus and connects electrostatic protection circuits to the common bus from the power supply lines and ground lines; thereby reduces the number of the protection circuits in comparison to the case in which the power supply lines and ground lines are individually mutually connected.

[Patent Document 1] Japanese Unexamined Patent Publication No. 2001-127249

[Patent Document 2] Japanese Unexamined Patent Publication No. 2000-208718

[Patent Document 3] Japanese Unexamined Patent Publication No. Hei 9(1997)-321225

[Patent Document 4] Japanese Unexamined Patent Publication No. Hei 8(1996)-148650

### SUMMARY OF THE INVENTION

The inventors of this application examined the above ESD protection circuits and found the following facts.

As a model for simulating an electrostatic breakdown of a semiconductor device, there are the human-body model, the machine model, and the device electrification model and so forth. The human-body model is a model to simulate the electrostatic breakdown generated by discharging the charges electrified on the human body to the device. The machine model is a model to simulate the electrostatic breakdown generated when a metal apparatus having a larger capacity and a smaller discharge resistance than a human body is brought into contact with the device. The device electrification model called the CDM (Charged Device Model) is a model to simulate the electrostatic breakdown generated by the package or the lead frame of the device being electrified by abrasion or the like and the charges being discharged through terminals of the device.

The electrostatic withstanding test by the CDM is carried out by using the test equipment as shown in FIG. 8. FIG. 8 is a chart for explaining the outline of the test by the CDM. In the withstanding test by the CDM, first, a semiconductor device 80 is set on an inspection plate 81 of the test equipment. Next, a high-voltage power supply 82 is connected to a tested terminal of the semiconductor device 80 by way of a resistor to electrify the semiconductor device 80. Here, all the terminals of the semiconductor device 80 are connected mutually by a resistor 83 of the test equipment, and substantially all the terminals are electrified. The charged voltage here is about 1500 V, for example. After the electrification is completed, a relay 84 of the test equipment is closed to connect the tested terminal to the ground. Thereby, the charges electrified on the semiconductor device 80 are discharged from the tested terminal.

In recent years, however, there are lots of semiconductor devices provided with plural operational voltages, such as SOC, system LSI, etc. With regard to such a semiconductor device, there increases a possibility of the electrostatic breakdown by the above CDM, as illustrated in FIG. 9. FIG. 9 is a chart for explaining the phenomenon of the electrostatic breakdown by the CDM, in a semiconductor device based on the technique that was examined on the premises of the present invention.

The semiconductor device illustrated in FIG. 9 includes a circuit block [1] 90 that operates with a supply voltage Vdd1 and a reference voltage Vss1 and a circuit block [2] 91 that operates with a supply voltage Vdd2 and a reference voltage Vss2. The output signal by a signal input circuit 90a of the circuit block [1] 90 is inputted to a signal input circuit 91a of the circuit block [2] 91. Here, the signal input circuit 90a and signal input circuit 91a are made up with, for example, CMOS inverters, and the MOS transistors being the constituents thereof contain parasitic diodes 90b, 91b.

The supply voltage Vdd1 and reference voltage Vss1 are supplied from the outside through pads 92, 93, and are supplied to the circuit block [1] 90 through the power supply line and the ground line (GND). The power supply line and the GND line near the pads 92, 93 are provided with clamp circuits 92a, 93a, respectively. The clamp circuits 92a, 93a are made up with, for example, diodes and MOS transistors and so forth, and they function to clamp the power supply line and the GND line to, for example, a common GND line Vssq provided for an input/output buffer of the semiconductor device.

The supply voltage Vdd2 and reference voltage Vss2 are supplied from the outside through pads 94, 95, in the same manner, and are supplied to the circuit block [2] 91 through the power supply line and the GND line. The power supply line and the GND line near the pads 94, 95 are provided with clamp circuits 94a, 95a, respectively.

In such a construction, it is assumed that the area of the circuit block [2] 91 is smaller than that of the circuit block [1] 90. Then, assuming that the whole semiconductor device illustrated in FIG. 9 is electrified to a high potential and the charges of the semiconductor device in that state are discharged through any pads, the circuit block [2] 91 is discharged faster than the circuit block [1] 90 because the wiring capacity and so forth of the circuit block [2] 91 is smaller. Then, in the discharge process, there can be a state that the power supply line and GND line of the circuit block [1] 90 retains a high potential although the power supply line and GND line of the circuit block [2] 91 has become a low potential. This potential difference is applied to the signal input circuit 91a of the circuit block [2] 91, which will cause destruction of the gates of the signal input circuit 91a.

When the charges are discharged from the power supply line and GND line inside the circuit block [2] 91, and the discharge paths of the power supply line and GND line are elongated, there can be a problem caused by a generated voltage due to the wiring resistance R and a time difference of the discharges. In some case, a high potential can occur between the power supply line and the GND line inside the circuit block [2] 91. If it happens, there will be a possibility that the circuits inside the circuit block [2] 91 are subjected to an electrostatic breakdown.

Accordingly, there are the following methods in order to prevent such an electrostatic breakdown: the first method is to insert the ESD protection circuits into the signal lines between different power supply lines, and the second method is to insert the ESD protection circuits between the power supply lines. The first method is implemented by inserting diodes that each clamp to the power supply line and the GND line into a signal line 96 leading to the signal input circuit 91a of the circuit block [2] 91. However, using this method will increase the number of the protection circuits in proportion to the increase of the number of the signal line 96, leading to increasing the circuit area, which is a problem to be solved. On the other hand, as the technique for using the second method, the aforementioned patent documents 1 though 4 can be listed as an example.

However, the patent document 1 does not disclose a sufficient construction for preventing the electrostatic breakdowns as mentioned with FIG. 9. The patent document 2 intends to reduce the high voltage resulting from that the clamp voltages and the voltages by wiring resistances are superposed. Thus, the technique according to the patent document 2 does not necessarily guarantee a construction for an optimum number of protection circuits at optimum locations in view of the electrostatic breakdowns as mentioned with FIG. 9. The patent document 3 discloses a construction of the clamp circuit based on MOS transistors, and does not disclose a sufficient construction that prevents the electrostatic breakdowns as mentioned with FIG. 9. The patent document 4 discloses a construction that discharge currents flow into a common bus, which creates an apprehension that noises transmit through the common bus.

Accordingly, an object of the present invention is to provide a semiconductor device capable of the preventing electrostatic breakdowns generated between plural power supply systems with a few number of protection circuits.

Another object of the present invention is to provide a semiconductor device capable of preventing an electrostatic breakdown especially by the CDM, of the electrostatic breakdowns generated between plural power supply systems.

Another object of the present invention is to provide a semiconductor device capable of preventing transmission of noises through plural power supply systems with a few number of protection circuits, in addition to the electrostatic breakdowns generated between plural power supply systems.

The aforementioned and other objects and novel features of the present invention will become apparent from the descriptions and appended drawings of this specification.

A summary of a typical one of the inventions disclosed in the present application will be explained in brief as follows.

According to one aspect of the invention, the semiconductor device has a first circuit block that operates with a first power supply voltage and a first reference voltage, and a second circuit block that operates with a second power supply voltage and a second reference voltage. The semiconductor device performs transmission and reception of signals between the first circuit block and the second circuit block. The semiconductor device further comprises a first clamp circuit that clamps a potential between the first power supply voltage and the second reference voltage, a second clamp circuit that clamps a potential between the second power supply voltage and the first reference voltage, and a third clamp circuit that clamps a potential between the first reference voltage and the second reference voltage.

When a high potential is generated between the power supply system for the first circuit block and the power supply system for the second circuit block, this construction can clamp the high potential difference before the circuit at the first input stage of the first circuit block or the second circuit block is broken down. The third clamp circuit can reinforce a discharge path between the first circuit block and the second circuit block, and can prevent transmission of noises between these circuit blocks.

In the semiconductor device according to the invention, the second circuit block further includes a fourth clamp circuit that clamps a potential between the second power supply voltage and the second reference voltage, when the circuit area of the second circuit block is smaller than that of the first circuit block.

Normally, a circuit block having a smaller circuit area is assumed to discharge earlier. When charges are made to flow from a circuit block having a larger circuit area toward a circuit block having a smaller circuit area, there is a possibility that there occurs a high potential between the power supplies for these circuit blocks due to wiring resistances and so forth of the circuit block having a smaller circuit area. Accordingly, adding the fourth clamp circuit will clamp this high potential difference. Thus, providing a minimum number of the first through the fourth clamp circuits will make it possible to fully prevent the electrostatic breakdown especially by the CDM.

According to another aspect of the invention, the semiconductor device includes a first power supply line connected to a first power supply terminal to which a first power supply voltage is supplied, a second power supply line connected to a second power supply terminal to which a first reference voltage is supplied, a third power supply line connected to a third power supply terminal to which a second power supply voltage is supplied, a fourth power supply line connected to a forth power supply terminal to which a second reference voltage is supplied, a first circuit block connected to the first power supply line and the second power supply line, a second circuit block connected to the third power supply line and the fourth power supply line, and signal lines connecting the first circuit block and the second circuit block. The semiconductor device has an I/O area including the first, the second, the third, and the fourth power supply terminals and plural input/output buffers arranged on the outer periphery of the semiconductor device, and a core area including the first circuit block and the second circuit block arranged in an area inside the I/O area. The core area includes a first clamp circuit connected between the first power supply line and the fourth power supply line, a second clamp circuit connected between the second power supply line and the third power supply line, and a third clamp circuit connected between the second power supply line and the fourth power supply line.

Thus, arranging the first through the third clamp circuits inside the core area will make it possible to shorten the wiring paths during discharges and reduce influences such as voltage generations by the wiring resistances.

In the semiconductor device according to the invention, the second circuit block further includes a fourth clamp circuit connected between the third power supply line and the fourth power supply line, when the circuit area of the second circuit block is smaller than that of the first circuit block.

Thus, including the fourth clamp circuit inside the second circuit block will reduce the wiring resistances of the power supply lines leading to a discharge sink. Therefore, a high potential becomes difficult to occur between the power supply lines of the second circuit block, and when there occurs a high potential, it can be clamped instantaneously.

According to another aspect of the invention, the semiconductor device includes a first circuit block that operates with a first power supply voltage and a first reference voltage, and plural circuit blocks that each operate with power supply voltages and reference voltages supplied from power supply systems different from the power supply system that supplies the first power supply voltage and the first reference voltage, and each perform transmission and reception of signals with the first circuit block. The semiconductor device further includes first plural circuits that clamp potentials between the first power supply voltage and reference voltages each supplied to the plural circuit blocks, second plural circuits that clamp potentials between the first reference voltage and power supply voltages each supplied to the plural circuit blocks, and third plural circuits that clamp potentials between the first reference voltage and the reference voltages each supplied to the plural circuit blocks.

In the semiconductor device according to the invention, each of the plural circuit blocks has a fourth circuit that clamps a potential between the power supply voltage and the reference voltage of its own, when each of the plural circuit blocks has a smaller circuit area than the first circuit block.

By these constructions, it becomes possible to prevent electrostatic breakdowns in a semiconductor device having multiple power supply voltages, with a few number of protection circuits.

As the above third clamp circuit and the third circuit, a bi-directional diode can be used as an example. As the first, the second, and the fourth clamp circuits, a diode, a MOS transistor forming the diode connection, or a GCNMOS circuit can be used as an example.

The present invention exhibits the following effects as typical ones.

Providing clamp circuits at minimum locations between the power supply lines of the plural power supply systems will make it possible to prevent the electrostatic breakdowns generated between the plural power supply systems. Of the breakdowns, especially, the breakdown by the CDM can be prevented. In addition to the above, it becomes possible to prevent transmission of noises generated between the plural power supply systems.

### BRIEF DESCRIPTION OF THE DRAWINGS

FIG. 1 is a circuit block diagram illustrating a construction of a semiconductor device according to one embodiment of the present invention;

FIG. 2 is a schematic layout diagram illustrating an arrangement of the circuit blocks of a semiconductor device illustrated in FIG. 10;

FIG. 3 is a circuit diagram illustrating a construction of the clamp circuit of a semiconductor device illustrated in FIG. 10;

FIGS. 4(a) and 4(b) show another construction of the clamp circuit of a semiconductor device illustrated in FIG. 10, in which FIG. 4 (a) illustrates a circuit diagram including the clamp circuit, and FIG. 4 (b) illustrates an operational characteristic of the clamp circuit;

FIGS. 5(a) to 5(c) show another construction of the clamp circuit of a semiconductor device illustrated in FIG. 10, in which FIG. 5 (a) illustrates a circuit diagram including the clamp circuit, FIG. 5 (b) illustrates a detailed circuit diagram of the clamp circuit, and FIG. 5 (c) illustrates an operational characteristic of the clamp circuit;

FIG. 6 is a circuit block diagram illustrating an expanded construction of a semiconductor device illustrated in FIG. 10;

FIG. 7 is a schematic layout diagram illustrating an arrangement of the circuit blocks of a semiconductor device illustrated in FIG. 6;

FIG. 8 is an explanatory chart for the outline of the test by the CDM;

FIG. 9 is an explanatory chart for the phenomenon of an electrostatic breakdown by the CDM, which will be generated in a semiconductor device based on the technique examined on the premises of the present invention; and

FIG. 10 is a circuit block diagram illustrating an expanded construction of a semiconductor device illustrated in FIG. 1.

### DETAILED DESCRIPTION OF THE PREFERRED EMBODIMENTS

The preferred embodiments of the present invention will be described with reference to the accompanying drawings. In all the descriptions of the embodiments, the same members will be given the same symbols in principle, and repeated descriptions thereof will be omitted.

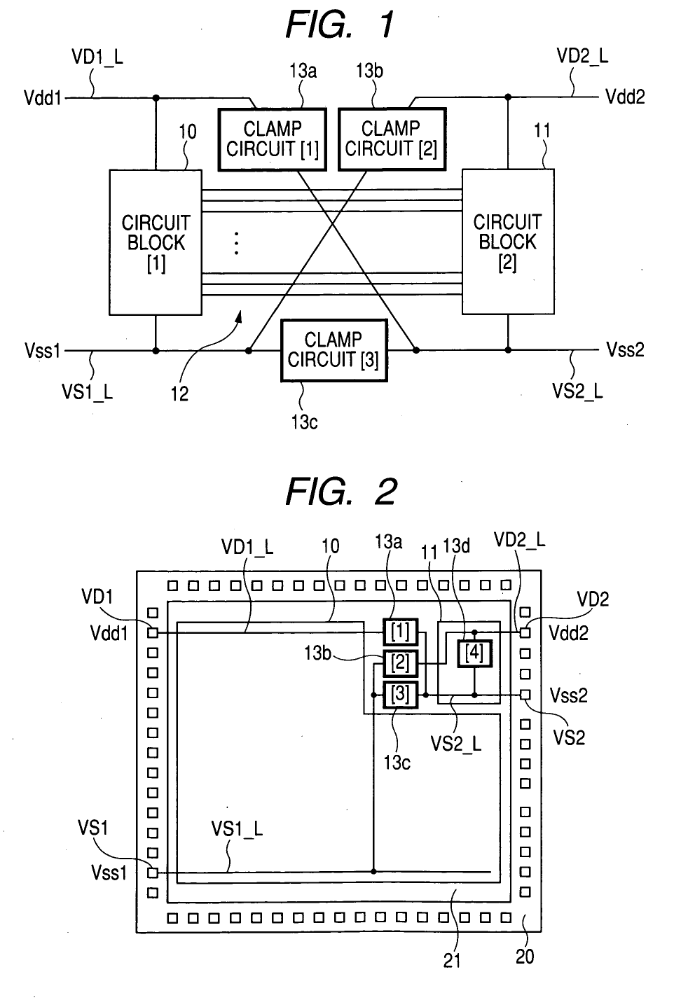

FIG. 1 illustrates a circuit block diagram of a semiconductor device as one embodiment of the invention. The semiconductor device illustrated in FIG. 1 includes a circuit block [1] 10 that operates with a power supply system [1] and a circuit block [2] 11, and performs transmission and reception by signal lines 12 between the circuit block [1] 10 and the circuit block [2] 11. Further, the semiconductor device includes clamp circuits [1] 13a, [2] 13b, [3] 13c between the power supply system [1] and a power supply system [2].

The power supply system [1] includes a power supply terminal VD1 (not illustrated) where a power supply voltage Vdd1 is supplied, a power supply terminal VS1 (not illustrated) where a reference voltage Vss1 is supplied, power supply lines VD1_L, VS1_L that are extended from the power supply terminals VD1, VS1, respectively, and so forth. In the same manner, the power supply system [2] includes a power supply terminal VD2 (not illustrated) where a power supply voltage Vdd2 is supplied, a power supply terminal VS2 (not illustrated) where a reference voltage Vss2 is supplied, power supply lines VD2_L, VS2_L that are extended from the power supply terminals VD2, VS2, respectively, and so forth.

The clamp circuit [1] 13a functions to clamp the potential between the power supply voltage Vdd1 and the reference voltage Vss2, the clamp circuit [2] 13b functions to clamp the potential between the power supply voltage Vdd2 and the reference voltage Vss1, and the clamp circuit [3] 13c functions to clamp the potential between the reference voltage Vss1 and the reference voltage Vss2 and further clamp the power supply voltage Vdd1 and power supply voltage Vdd2 by way of the clamp circuit [1] 13a and the clamp circuits [2] 13b. Here, the clamp circuits. [1] 13a through [3] 13c are made up with, for example, diodes and so forth, the detail of which will be described later.

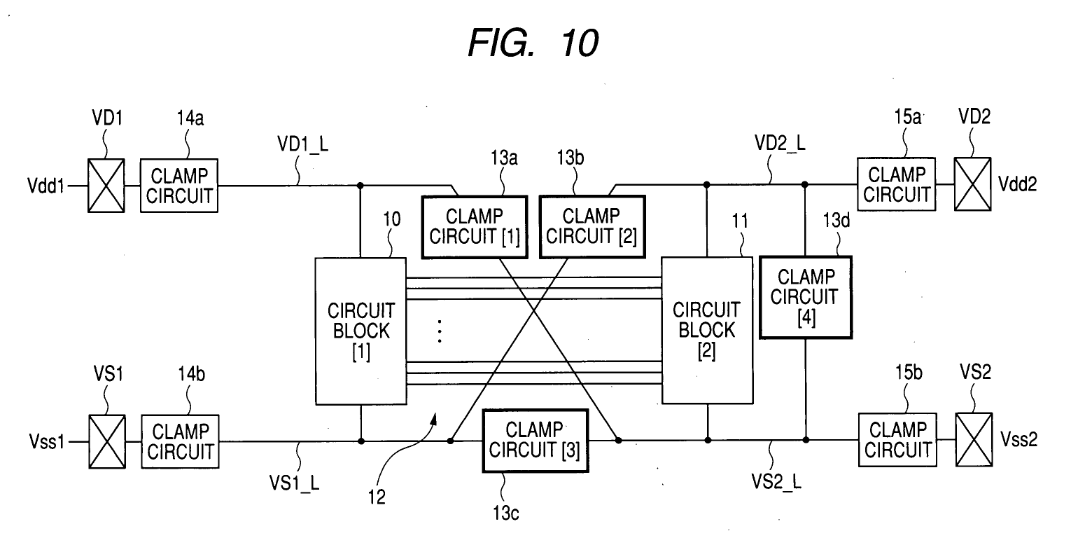

FIG. 10 is a circuit block diagram illustrating an expanded construction of a semiconductor device illustrated in FIG. 1. FIG. 2 is a schematic layout diagram illustrating an arrangement of the circuit blocks of the semiconductor device illustrated in FIG. 10. The semiconductor device illustrated in FIG. 10 includes, in addition to the construction illustrated in FIG. 1, clamp circuits near the power supply terminals of the power supply system [1] and power supply system [2], and a clamp circuit [4] 13d inside or near the circuit block [2], which clamps the potential between the power supply lines VD2_L, VS2_L.

The semiconductor device illustrated in FIG. 10 includes the circuit block [1] 10 and that operates with the power supply system [1], and the circuit block [2] 11 that operates with the power supply system [2], the circuit area of which is smaller than that of the circuit block [1], and performs transmission and reception by signal lines 12 between the circuit block [1] 10 and the circuit block [2] 11. Further, the semiconductor device includes clamp circuits [1] 13a, [2] 13b, [3] 13c between the power supply system [1] and a power supply system [2], and the clamp circuit [4] 13d inside the power supply system [2].

The power supply system [1] includes the power supply terminal VD1 where the power supply voltage Vdd1 is supplied, the power supply terminal VS1 where the reference voltage Vss1 is supplied, the power supply lines VD1_L, VS1_L that are extended from the power supply terminals VD1, VS1, respectively, and clamp circuits 14a and 14b near the power supply terminals VD1, VS1 on the power supply lines. In the same manner, the power supply system [2] includes the power supply terminal VD2 where the power supply voltage Vdd2 is supplied, the power supply terminal VS2 where the reference voltage Vss2 is supplied, the power supply lines VD2_L, VS2_L that are extended from the power supply terminals VD2, VS2, respectively, and clamp circuits 15a and 15b near the power supply terminals VD2, VS2 on the power supply lines.

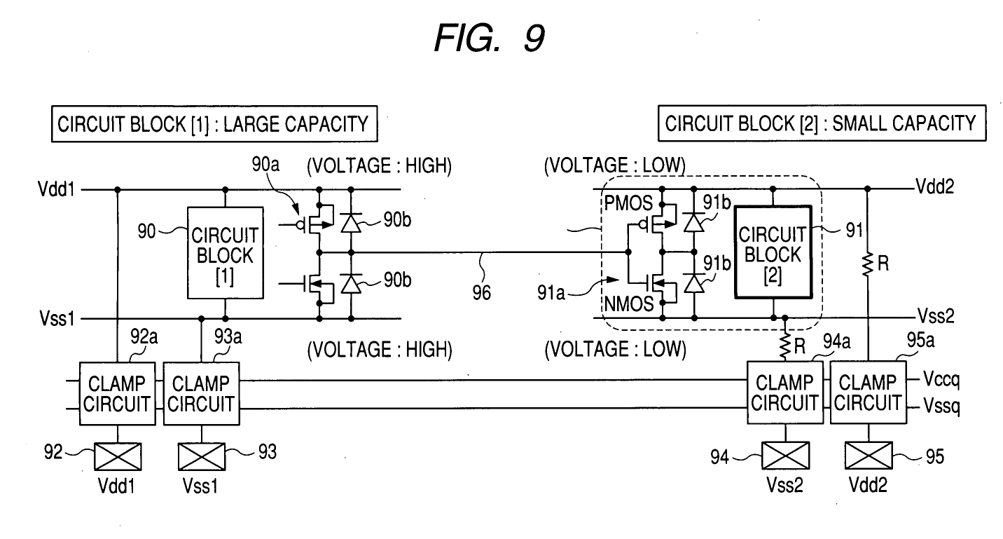

The clamp circuits 14a, 14b, 15a, and 15b near the power supply terminals are the same as the clamp circuits as mentioned with FIG. 9, which function to clamp the power supply lines VD1_L, VD2_L, VS1_L, and VS2_L to a common ground line (not illustrated) or the like.

The clamp circuit [1] 13a functions to clamp the potential between the power supply voltage Vdd1 and the reference voltage Vss2, the clamp circuit [2] 13b functions to clamp the potential between the power supply voltage Vdd2 and the reference voltage Vss1, and the clamp circuit [3] 13c functions to clamp the potential between the reference voltage Vss1 and the reference voltage Vss2 and further clamp the power supply voltage Vdd1 and power supply voltage Vdd2 by way of the clamp circuit [1] 13a and the clamp circuits [2] 13b. The clamp circuit [4] 13d functions to clamp the potential between the power supply voltage Vdd2 and the reference voltage Vss2. Here, the clamp circuits [1] 13a through [4] 13d are made up with, for example, diodes and so forth, the detail of which will be described later.

The semiconductor device as such takes on a layout as shown in FIG. 2, for example. In FIG. 2, an I/O area 20 is disposed on the outer periphery of the device. The I/O area 20 includes multiple pads served as the power supply terminals VD1, VD2, VS1, and VS2 and other signal terminals, the clamp circuits 14a, 14b, 15a, and 15b near the power supply terminals, and input/output buffers that perform input/output of signals with the outside.

On the other hand, the semiconductor device in FIG. 2 has a core area 21 in the inner area excluding the I/O area 20. The core area contains the circuit block [1] 10 that operates with the power supply system [1] and the circuit block [2] 11 that operates with the power supply system [2], the area of which is smaller than that of the circuit block [1] 10.

The circuit block [1] 10 is supplied with the power supply voltage Vdd1 and the reference voltage Vss1 from the power supply terminals VD1 and VS1, respectively, inside the I/O area 20, and these voltages are supplied to the circuits inside the circuit block [1] 10 by way of the power supply lines VD1_L and VS1_L. On the other hand, the circuit block [2] 11 is supplied with the power supply voltage Vdd2 and the reference voltage Vss2 from the power supply terminals VD2 and VS2, respectively, inside the I/O area 20, and these voltages are supplied to the circuits inside the circuit block [2] 11 by way of the power supply lines VD2_L and VS2_L. These power supply lines VD1_L, VD2_L, VS1_L and VS2_L are formed in a den-droid shape or an annular shape or the like.

The clamp circuits [1] 13a, [2] 13b, and [3] 13c are located at the joint position of the circuit block [1] 10 and the circuit block [2] 11, in the core area 21. To locate the clamp circuits [1] 13a, [2] 13b, and [3] 13c at such a position as the above will shorten current paths during discharges of the circuit blocks and reduce influences such as voltage generations by wiring resistances and so forth. The clamp circuit [1] 13a has one end connected to the power supply line VD1_L and has the other end connected to the power supply line VS2_L. The clamp circuit [2] 13b has one end connected to the power supply line VD2_L and has the other end connected to the power supply line VS1_L. The clamp circuit [3] 13c has one end connected to the power supply line VS1_L and has the other end connected to the power supply line VS2_L.

Further, inside the circuit block [2] 11 is provided the clamp circuit [4] 13d that has one end connected to the power supply line VD2_L and has the other end connected to the power supply line VS2_L. There are the signal lines 12 that connect the circuit block [1] 10 and the circuit block [2] 11 and so forth, which are omitted in FIG. 2.

Next, the operation of the semiconductor device illustrated in FIG. 10 and FIG. 2 will be described, including the operational explanation of the semiconductor device illustrated in FIG. 1. The description here will be made on the assumption of the breakdown by the CDM in the same manner as the explanation with FIG. 9.

First of all, it is assumed that discharges are generated through arbitrary terminals of the semiconductor device while the whole semiconductor device is electrified to a high potential. Then, the discharges in the circuit block [2] 11 of which wiring capacity and so forth are smaller in proportion to the circuit area are generated at an earlier time compared with the circuit block [1] 10. Thereby, there occurs a state that the power supply lines VD1_L and VS1_L of the circuit block [1] 10 are brought to a high potential, and the power supply lines VD2_L and VS2_L of the circuit block [2] 11 are brought to a low potential.

Now, using the clamp circuits [1] 13a through [3] 13c will make it possible to clamp the high potential between the power supply lines VD1_L and VS1_L of the circuit block [1] 10 to the low potential between the power supply lines VD2_L and VS2_L of the circuit block [2] 11, before the MOS transistors and so forth at the first input stages of the circuit block [2] 11 are broken down. The charges are made to flow into the power supply lines VD2_L and VS2_L of the circuit block [2] 11 from the power supply lines VD1_L and VS1_L of the circuit block [1] 10.

In the conventional technique, the has been a possibility that the wiring resistances of the power supply lines VD2_L and VS2_L leading to the clamp circuits 15a and 15b inside the I/O area 20 and the small capacitance across the power supply lines of the circuit block [2] 11 will generate a high potential leading to a device breakdown. Accordingly, the present invention provides the clamp circuit [4] 13d inside the area of the circuit block [2] 11 (not in the I/O area 20), as shown in FIG. 2, which clamps the potential between the power supply lines VD2_L and VS2_L of the circuit block [2] 11.

Thereby, since the influences by the wiring resistances are reduced, the high potential between the power supply lines of the circuit block [2] 11 becomes difficult to be generated. If a high potential is generated, it can be clamped instantly, which will prevent the electrostatic breakdowns of the circuits inside the circuit block [2] 11. The clamp circuit [3] 13c will prevent transmission of noises between the grounds of the circuit block [1] 10 and the circuit block [2] 11.

It is also possible to insert a clamp circuit between the power supply line VD1_L of the circuit block [1] 10 and the power supply line VD2_L of the circuit block [2] 11 in order to further reinforce the discharge paths. In this case however, there is a possibility of malfunction being generated depending on the order of applying the voltages to the power supply terminals VD1 and VD2. The clamp circuits [1] 13a through [3] 13c are able to sufficiently clamp the potential between the power supply lines VD1_L, VD2_L. From these reasons and from a view point of reducing the circuit area, it is not advisable to insert a clamp circuit between the power supply lines VD1_L, VD2_L.

The aforementioned operation will be described with a further detailed example. First of all, it is assumed that electrified charges are discharged toward the power supply terminal VD2 of the circuit block [2] 11. The charges on the power supply line VD1_L of the circuit block [1] 10 are discharged through a route of connecting the clamp circuit [1] 13a, the clamp circuit [3] 13c, and the clamp circuit [2] 13b, and through a route of connecting the clamp circuit [1] 13a and the clamp circuit [4] 13d. On the other hand, the charges on the power supply line VS1_L of the circuit block [1] 10 are discharged through a route of the clamp circuit [2] 13b and through a route of connecting the clamp circuit [3] 13c and the clamp circuit [4] 13d.

Next, it is assumed that electrified charges are discharged toward the power supply terminal VS2 of the circuit block [2] 11. In this case, the charges on the power supply line VD1_L of the circuit block [1] 10 are discharged through a route of the clamp circuit [1] 13a. On the other hand, the charges on the power supply line VS1_L of the circuit block [1] 10 are discharged through a route of the clamp circuit [3] 13c and through a route of connecting the clamp circuit [2] 13b the clamp circuit [4] 13d.

If the discharge sink is one-sided to any one of the power supply terminals VD2, VS2, that is, if discharges are generated by grounding one power supply terminal, or if unevenness on the layout is made, there occurs a remarkably high potential between the power supply lines VD2_L, VS2_L of the circuit block [2] 11, in the conventional technique. However, the present invention provides the clamp circuit [4] 13d, which does not cause such a problem.

Using the semiconductor device as shown in FIG. 1 and FIG. 2 will achieve the effects as follows.
(1) The electrostatic breakdowns generated between plural power supply systems can be prevented with a few number of protection elements including the clamp circuits [1] through [3] or the clamp circuits [1] through [4]. That is, the prevention of the electrostatic breakdowns becomes possible with a small area. Especially, there is a beneficial effect to the electrostatic breakdown by the CDM.
(2) In addition to the effect of (1), the prevention of noise transmission between the plural power supply systems becomes possible with the clamp circuit [3].
(3) Owing to the effects (1) and (2), it becomes possible to implement an ESD protection circuit effective in use for a microcomputer, SOC, system LSI, or analog/digital mixed circuit.

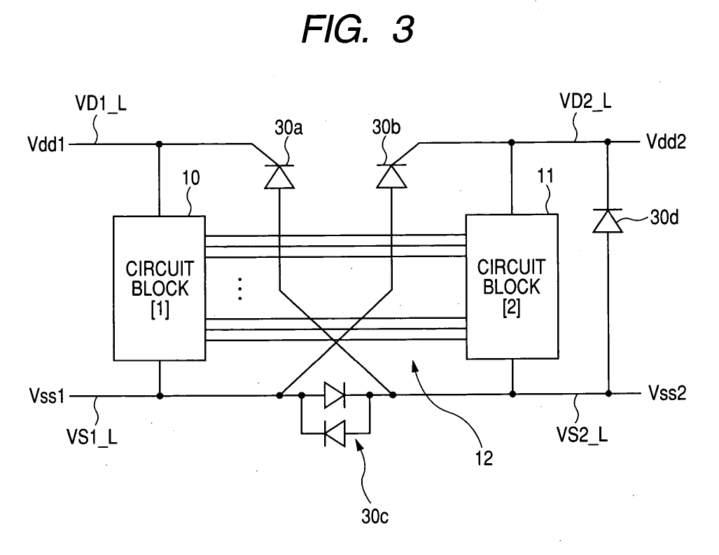

Next, a concrete construction of the clamp circuits [1] through [4] will be described with FIG. 3 through FIG. 5.

FIG. 3 illustrates a construction of the clamp circuit of the semiconductor device illustrated in FIG. 10. In FIG. 3, the clamp circuits [1] 13a, [2] 13b, and [4] 13d in FIG. 10 are configured with diodes [1] 30a, [2] 30b, and [4] 30d, respectively, and the clamp circuit [3] 13c is configured with a bi-directional diode 30c. The diode [1] 30a has the anode connected to the power supply line VS2_L of the circuit block [2] 11, and has the cathode connected to the power supply line VD1_L of the circuit block [1] 10. The diode [2] 30a has the anode connected to the power supply line VS1_L of the circuit block [1] 10, and has the cathode connected to the power supply line VD2_L of the circuit block [2] 11. The diode [4] 30d has the anode connected to the power supply line VS2_L of the circuit block [2] 11, and has the cathode connected to the power supply line VD2_L of the circuit block [2] 11.

The bi-directional diode 30c is configured with two diodes that are connected in parallel in mutually reverse directions. To one end connected to the power supply line VS1_L of the circuit block [1] 10 are connected the anode of one diode and the cathode of the other diode; and to the other end connected to the power supply line VS2_L of the circuit block [2] 11 are connected the cathode of the one diode and the anode of the other diode.

When a higher voltage is applied to the power supply line VD1_L of the circuit block [1] 10 against a voltage on the power supply line VS2_L of the circuit block [2] 11, the diode [1] 30a has a reverse voltage applied and performs the clamping by the avalanche breakdown. The withstanding voltage of the avalanche breakdown is designed to a lower voltage than, for example, a critical voltage within which the gate breakdown at the input first stage of the circuit block [2] 11 is withstood. In reverse to the above, when a higher voltage is applied to the power supply line VS2_L against a voltage on the power supply line VD1_L, the diode [1] 30a has a forward voltage applied; and when the voltage across the diode [1] 30a is higher than about 0.7 V, the diode [1] 30a performs the clamping operation. The diodes [2] 30b, [4] 30d perform the same operation except the difference of the signal lines.

The bi-directional diode 30c performs the clamping, when a voltage higher than about 0.7 V is generated between the power supply line VS1_L of the circuit block [1] 10 and the power supply line VS2_L of the circuit block [2] 11. In this case, the diode 30c can perform a high-speed clamping by a high current because any one of the two diodes is forward biased. On the other hand, when the voltage is lower than about 0.7 V, the clamping is not performed. Therefore, using the bi-directional diode 30c makes it possible to separate noises lower than about 0.7 V generated between the power supply line VS1_L and the power supply line VS2_L, without transmitting the noises.

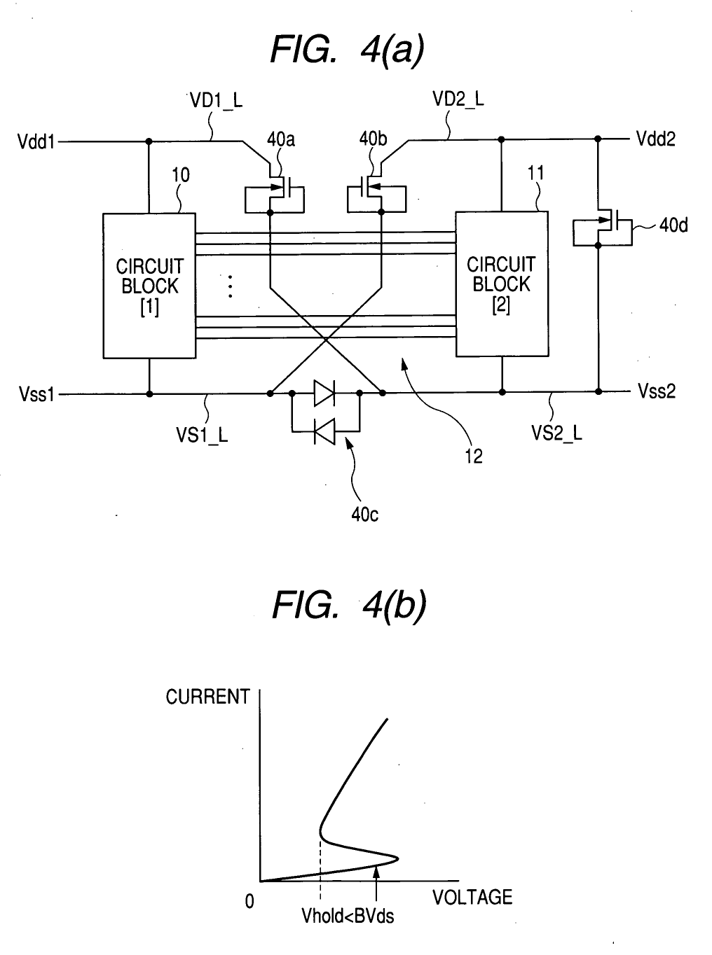

FIGS. 4(a) and 4(b) illustrate another construction of the clamp circuit of the semiconductor device illustrated in FIG. 10, in which FIG. 4 (a) illustrates a circuit diagram including the clamp circuit, and FIG. 4 (b) illustrates an operational characteristic of the clamp circuit. In FIG. 4(a), the clamp circuits [1] 13a, [2] 13b, and [4] 13d in FIG. 10 are configured with MOS transistors [1] 40a, [2] 40b, and [4] 40d forming the diode connection, respectively, and the clamp circuit [3] 13c is configured with a bi-directional diode 40c in the same manner as FIG. 3

The MOS transistors [1] 40a, [2] 40b, and [4] 40d are, for example, an N-channel MOS transistor. The gate terminals and the drain terminals thereof are commonly connected to form the diode connections. The source terminal of the MOS transistor [1] 40a is connected to the power supply line VD1_L of the circuit block [1] 10, and the commonly connected gate and drain terminals are connected to the power supply line VS2_L of the circuit block [2] 11.

The source terminal of the MOS transistor [2] 40b is connected to the power supply line VD2_L of the circuit block [2] 11, and the commonly connected gate and drain terminals are connected to the power supply line VS1_L of the circuit block [1] 10. The source terminal of the MOS transistor [4] 40d is connected to the power supply line VD2_L of the circuit block [2] 11, and the commonly connected gate and drain terminals are connected to the power supply line VS2_L of the circuit block [2] 11. Here, the diode connection is made by using N-channel MOS transistors; however naturally, the diode connection can be made by using P-channel MOS transistors.

The MOS transistor [1] 40a performs the same operation as the forward characteristic of a diode, when a higher voltage is applied to the power supply line VS2_L of the circuit block [2] 11 against the power supply line VD1_L of the circuit block [1] 10. The MOS transistor [1] 40a performs the clamping operation, when the voltage is higher than the threshold voltage (about 0.7 V). In reverse to the above, when a higher voltage is applied to the power supply line VD1_L of the circuit block [1] 10 against the power supply line VS2_L of the circuit block [2] 11, the MOS transistor [1] 40a behaves as the voltage vs. current characteristic as shown in FIG. 4 (b)

The characteristic in FIG. 4(b) shows that the clamping starts at the moment that the applied voltage reaches the withstanding voltage BVds between the source and the drain of the MOS transistor, and thereafter, while maintaining the clamping by the snap-back phenomenon where a parasitic bipolar transistor of the MOS transistor becomes ON, the clamping voltage lowers to Vhold. Therefore, the design of the MOS transistor [1] 40a needs to set the withstanding voltage BVds to a lower value than, for example, a critical voltage within which the gate breakdown at the input first stage of the circuit block [2] 11 is withstood. The MOS transistors [2] 40b, [4] 40d perform the same operation except the difference of the power supply lines.

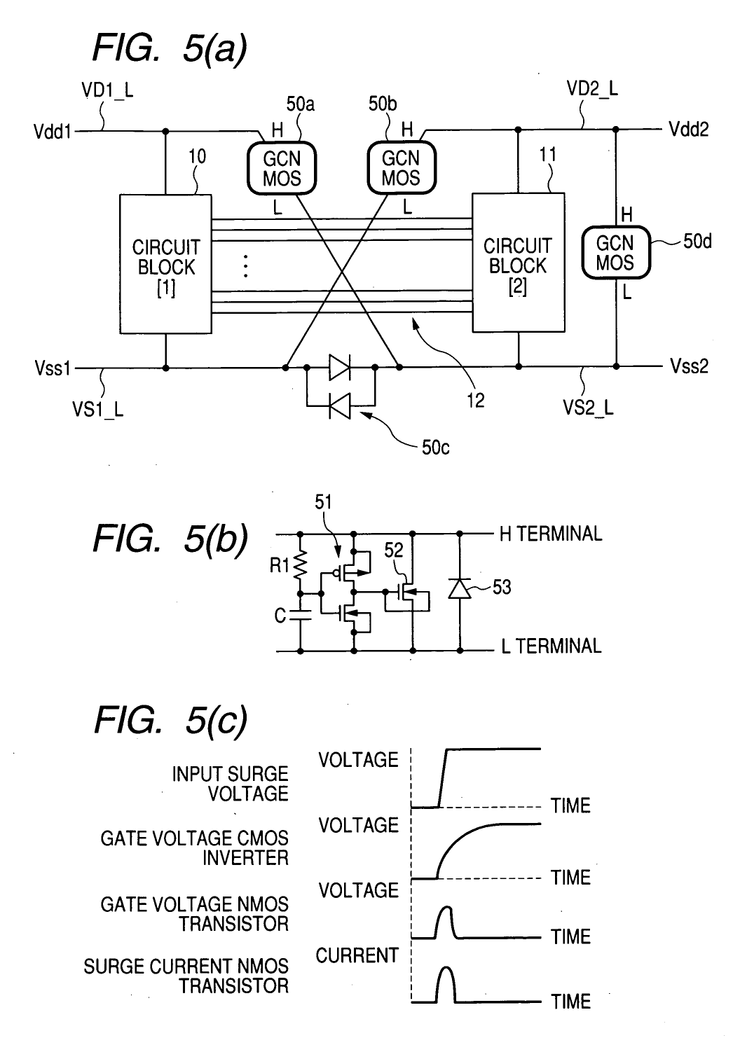

FIGS. 5(a) to 5(c) illustrate another construction of the clamp circuit of the semiconductor device illustrated in FIG. 10, in which FIG. 5 (a) illustrates a circuit diagram including the clamp circuit, FIG. 5 (b) illustrates a detailed circuit of the clamp circuit, and FIG. 5 (c) illustrates an operational characteristic of the clamp circuit. In FIG. 5(a), the clamp circuits [1] 13a, [2] 13b, and [4] 13d in FIG. 10 are configured with GCNMOS (Gate Coupled NMOS) circuits [1] 50a, [2] 50b, and [4] 50d, respectively, and the clamp circuit [3] 13c is configured with a bi-directional diode 50c in the same manner as FIG. 3.

The GCNMOS circuit [1] 50a has the H terminal connected to the power supply line VD1_L of the circuit block [1] 10, and has the L terminal connected to the power supply line VS2_L of the circuit block [2] 11. The GCNMOS circuit [2] 50b has the H terminal connected to the power supply line VD2_L of the circuit block [2] 11, and has the L terminal connected to the power supply line VS1_L of the circuit block [1] 10. The GCNMOS circuit [4] 50d has the H terminal connected to the power supply line VD2_L of the circuit block [2] 11, and has the L terminal connected to the power supply line VS2_L of the circuit block [2] 11.

The detailed circuit of the GCNMOS circuits [1] 50a, [2] 50b, and [4] 50d is shown in FIG. 5(b). and the GCNMOS circuit includes a resistor R1 and a capacitor C connected in series from the H terminal to the L terminal, a CMOS inverter circuit 51 that has the H terminal and the L terminal as the power supply voltage and the reference voltage and the node of the resistor R1 and the capacitor C is connected to the signal input terminal thereof, an N-channel MOS transistor 52, the gate terminal and the substrate potential terminal of which are connected to the output terminal of the CMOS inverter circuit 51, and one of the source terminal and the drain terminal is connected to the H terminal and the other is connected to the L terminal, and a diode 53, the cathode of which is connected to the H terminal and the anode is connected to the L terminal.

The operation of the GCNMOS circuit is outlined in FIG. 5(c). First, when a comparably low positive surge voltage (for example, not higher than about 5.5 V) is applied to the H terminal, the input voltage of the CMOS inverter circuit 51 increasingly rises according to the time constant determined by the resistor R1 and the capacitor C. While the input voltage rises, during the period in which the input voltage of the CMOS inverter circuit 51 is regarded as ‘L’, the output voltage from the CMOS inverter circuit 51 (the input voltage to the NMOS transistor 52) becomes ‘H’, which makes it possible to make the surge current flow from the H terminal toward the L terminal. Next, when a comparably high positive surge voltage (for example, higher than about 5.5 V) is applied to the H terminal, in addition to the above operation, the parasitic bipolar transistor (not illustrated) of the NMOS transistor becomes ON, which makes it possible to make the surge current flow from the H terminal toward the L terminal.

On the other hand, when a negative surge voltage (for example, not higher than about −0.7 V) is applied to the H terminal, the diode 53 is forward biased, which makes it possible to make the surge current flow from the L terminal toward the H terminal. Thus, by using the GCNMOS circuits, the clamping becomes possible even when a comparably low positive surge voltage is applied to the H terminal. Therefore, in comparison to the aforementioned MOS transistors forming the diode connection, this method using the GCNMOS circuits is able to protect the device from the breakdowns easily and sufficiently.

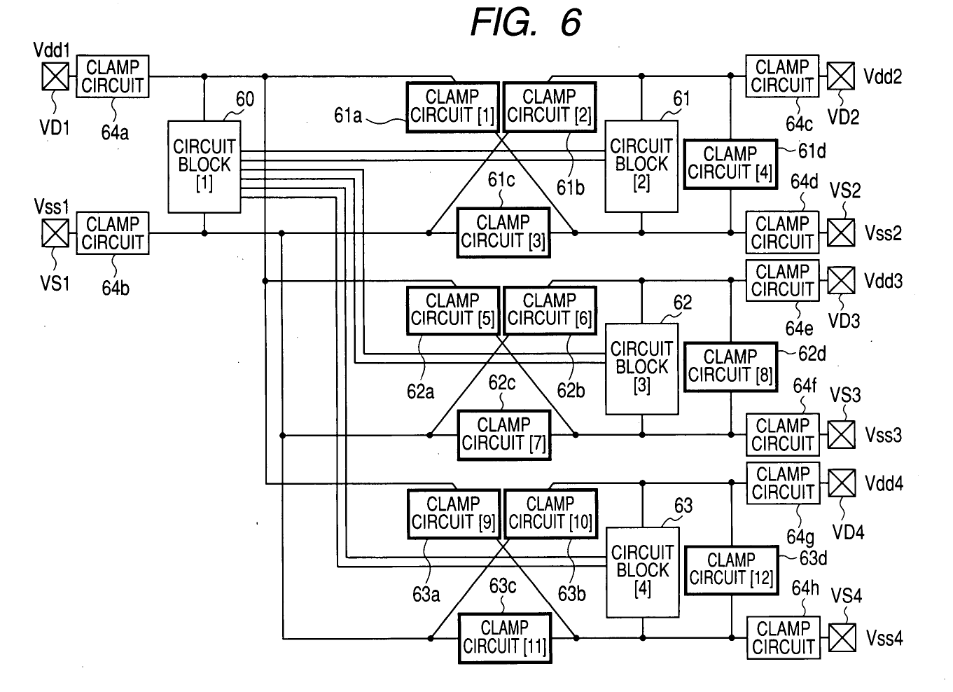

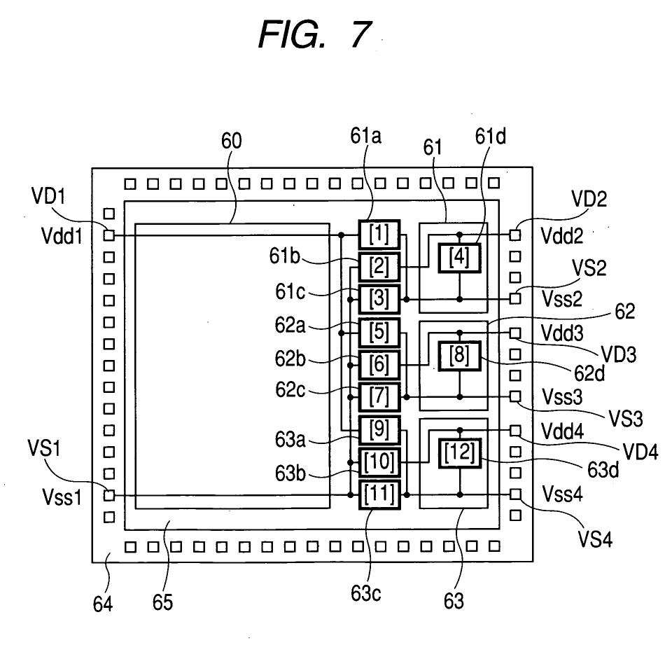

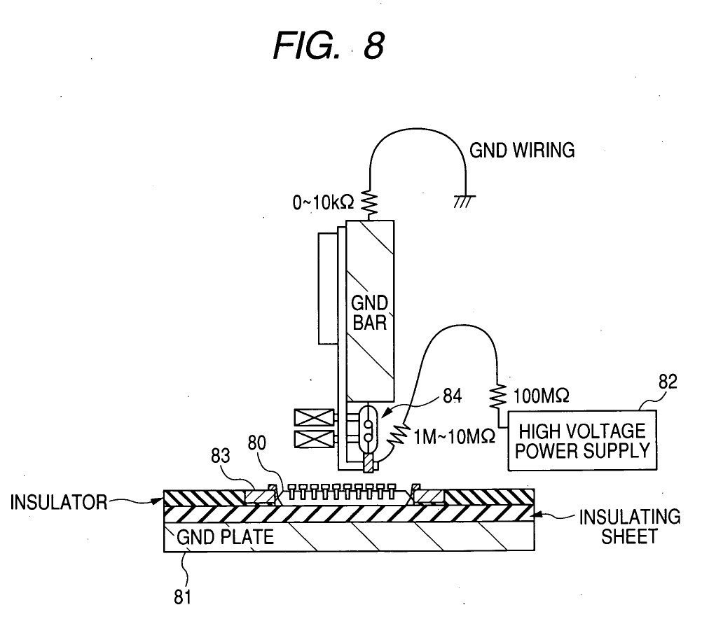

The description up to now has adopted a case having two power supply systems. In case of the device having, for example, four power supply systems, the construction will be as shown in FIG. 6 and FIG. 7. FIG. 6 illustrates a circuit block of an expanded construction of the semiconductor device illustrated in FIG. 10. FIG. 7 illustrates a schematic layout of the circuit blocks of the semiconductor device illustrated in FIG. 6. In the following description, the same items as those in FIG. 1 and FIG. 2 will be omitted.

The semiconductor device illustrated in FIG. 6 includes a circuit block [1] 60 that operates with a power supply system [1], and circuit blocks [2] 61, [3] 62, and [4] 63 that operate with power supply systems [2], [3], and [4], respectively, the circuit areas of which are smaller than that of the circuit block [1] 60. The semiconductor device performing transmission and reception of signals between the circuit block [1] 60 and each of the circuit blocks [2] 61 through [4] 63, includes clamp circuits at the following locations.

Clamp circuits [1] 61a, [2] 61b, and [3] 61c are located between the power supply system [1] and the power supply system [2]. Clamp circuits [5] 62a, [6] 62b, and [7] 62c are located between the power supply system [1] and the power supply system [3]. Clamp circuits [9] 63a, [10] 63b, and [11] 63c are located between the power supply system [1] and the power supply system [4]. Further, a clamp circuit [4] 61d is located inside the power system [2], a clamp circuit [8] 62d is located inside the power system [3], and a clamp circuit [12] 63d is located inside the power system [4].

The power supply system [1] includes the power supply terminal VD1 where the power supply voltage Vdd1 is supplied and the power supply terminal VS1 where the reference voltage Vss1 is supplied and so forth; and the power supply system [2] includes the power supply terminal VD2 where the power supply voltage Vdd2 is supplied and the power supply terminal VS2 where the reference voltage Vss2 is supplied and so forth. The power supply system [3] includes a power supply terminal VD3 where a power supply voltage Vdd3 is supplied and a power supply terminal VS3 where a reference voltage Vss3 is supplied and so forth; and the power supply system [4] includes a power supply terminal VD4 where a power supply voltage Vdd4 is supplied and a power supply terminal VS4 where a reference voltage Vss4 is supplied and so forth. These power supply systems also include clamp circuits 64a through 64h near the power supply terminals, which is the same as FIG. 10.

The clamp circuits [1] 61a through [4] 61d have the same construction and function as the clamp circuits [1] 13a through [4] 13d that are already explained with FIG. 10 and so forth. The clamp circuits [5] 62a through [8] 62d have the same construction and function as the clamp circuits [1] 61a through [4] 61d, except that the power system [2] becomes the power system [3]. The clamp circuits [9] 63a through [12] 63d have the same construction and function as the clamp circuits [1] 61a through [4] 61d, except that the power system [2] becomes the power system [4].

Such a semiconductor device is designed with a layout as shown in FIG. 7, for example. In the same manner as FIG. 2, the layout as shown in FIG. 7 contains an I/O area 64 and a core area 65. The I/O area 64 includes multiple pads served as the power supply terminals VD1 through VD4 and VS1 through VS4 and other signal terminals, the clamp circuits 64a through 64h (not illustrated in FIG. 7) near the power supply terminals, and input/output buffers that perform input/output of signals with the outside and so forth.

On the other hand, the core area 65 contains the circuit block [1] 60, and the circuit blocks [2] 61 through [4] 63, the circuit areas of which are smaller than that of the circuit block [1] 61. The clamp circuits [1] 61a, [2] 61b, and [3] 61c are located at the joint position of the circuit block [1] 60 and the circuit block [2] 61, in the same manner as FIG. 2. The clamp circuits [5] 62a, [6] 62b, and [7] 62c are located at the joint position of the circuit block [1] 60 and the circuit block [3] 62 in the same manner as clamp circuits [1] 61a, [2] 61b, and [3] 61c. The clamp circuits [9] 63a, [10] 63b, and [11] 63c are located at the joint position of the circuit block [1] 60 and the circuit block [4] 63 in the same manner as clamp circuits [1] 61a, [2] 61b, and [3] 61c. Further, the clamp circuit [4] 61d is located inside the circuit block [2] 61 in the same manner as FIG. 2, the clamp circuit [8] 62d is located inside the circuit block [3] 62 in the same manner as the clamp circuit [4-] 61d, and the clamp circuit [12] 63 dislocated inside the circuit block [4] 63 in the same manner as the clamp circuit [4] 61d.

The operation of the semiconductor device illustrated in FIG. 6 and FIG. 7 is the same as the semiconductor device in FIG. 1 and FIG. 2. That is, during discharges by the CDM, for example, the discharges are generated from the circuit block [1] 60 having a larger circuit area toward the circuit blocks [2] 61, [3] 62, and [4] 63 having smaller circuit areas. Here, the clamp circuits [1] 61a through [3] 61c, [5] 62a through [7] 62c, and [9] 63a tough [11] 63c and the clamp circuits [4] 61d, [8] 62d, and [12] 63d located inside the circuit blocks [2] 61, [3] 62, and [4] 64 prevent the breakdown of devices inside the circuit blocks [2] 61, [3] 62, and [4] 64. The other effects are the same as those mentioned with FIG. 10 and so forth.

In the descriptions up to now, from a view point of reducing the circuit area, the clamp circuits [4] and so forth that clamp the potentials between the power supply systems are inserted in the circuit blocks having comparably small areas. However, in view of a case that discharges are generated by grounding the power supply terminals of the circuit block having a comparably large area, when there is an apprehension that a high potential is generated between the power supply terminals because of an insufficiency of the power supply capacity to the circuit block having a comparably large area or the like, it is conceivable to insert a same one as the clamp circuit [4] in the circuit block having a larger area.

The above descriptions have been made with attention to the CDM giving remarkable effects. Since the power supply capacity increases owing to the construction that clamps the potential between the power supply lines, the withstanding capability against the electrostatic breakdown can be enhanced to the human-body model and the machine model.

The invention made by the present inventors being described concretely based on the preferred embodiments, the present invention is not confined to the aforementioned embodiments, and it should be well understood that various changes and modifications are possible to a person having ordinary skill in the art without a departure from the sprit and scope of the invention.

The technique in the semiconductor device of the present invention is especially effective for preventing the breakdown by the CDM between different power supply lines, in a SOC or system LSI and so forth that operate with plural power supply systems and require a smaller circuit area and resistance against noises. It is widely applicable to all the semiconductor devices including circuits that operate with plural power supply systems, as a technique to prevent the electrostatic breakdown.

What is claimed is:

1. A semiconductor device comprising:
a first circuit block that operates with a first power supply voltage and a first reference voltage;
a second circuit block that operates with a second power supply voltage and a second reference voltage, wherein the second circuit block performs transmission and reception of signals to the first circuit block;
a first clamp circuit that clamps a potential between the first power supply voltage and the second reference voltage;
a second clamp circuit that clamps a potential between the second power supply voltage and the first reference voltage; and
a third clamp circuit that clamps a potential between the first reference voltage and the second reference voltage.

2. A semiconductor device according to claim 1,
wherein the circuit area of the second circuit block is smaller than that of the first circuit block, and
wherein the second circuit block further includes a fourth clamp circuit that clamps a potential between the second power supply voltage and the second reference voltage.

3. A semiconductor device according to clam 1 or claim 2,
wherein the third clamp circuit includes a bi-directional diode.

4. A semiconductor device according to claim 2,
wherein the first, the second, and the fourth clamp circuits include a MOS transistor forming a diode connection.

5. A semiconductor device according to claim 2,
wherein the first, the second, and the fourth clamp circuits include a GCNMOS circuit.

6. A semiconductor device comprising:
a first power supply line connected to a first power supply terminal to which a first power supply voltage is supplied;
a second power supply line connected to a second power supply terminal to which a first reference voltage is supplied;
a third power supply line connected to a third power supply terminal to which a second power supply voltage is supplied;
a fourth power supply line connected to a forth power supply terminal to which a second reference voltage is supplied;
a first circuit block connected to the first power supply line and the second power supply line;
a second circuit block connected to the third power supply line and the fourth power supply line; and
signal lines connecting the first circuit block and the second circuit block,
wherein an I/O area including the first, the second, the third, and the fourth power supply terminals and plural input/output buffers is arranged on the outer periphery of the semiconductor device, and
wherein a core area including the first circuit block and the second circuit block is arranged in an area inside the I/O area,
the core area comprising:
a first clamp circuit connected between the first power supply line and the fourth power supply line;
a second clamp circuit connected between the second power supply line and the third power supply line; and
a third clamp circuit connected between the second power supply line and the fourth power supply line.

7. A semiconductor device according to claim 6,
wherein the circuit area of the second circuit block is smaller than that of the first circuit block, and
wherein the second circuit block further includes a fourth clamp circuit connected between the third power supply line and the fourth power supply line.

8. A semiconductor device including a first circuit block that operates with a first power supply voltage and a first reference voltage, and plural circuit blocks that each operate with power supply voltages and reference voltages supplied from power supply systems different from the power supply system that supplies the first power supply voltage and the first reference voltage, and each perform transmission and reception of signals with the first circuit block,
the semiconductor device comprising:
first plural circuits that clamp potentials between the first power supply voltage and reference voltages each supplied to the plural circuit blocks;
second plural circuits that clamp potentials between the first reference voltage and power supply voltages each supplied to the plural circuit blocks; and
third plural circuits that clamp potentials between the first reference voltage and reference voltages each supplied to the plural circuit blocks.

9. A semiconductor device according to claim 8,
wherein each of the plural circuit blocks has a smaller circuit area than the first circuit block, and
wherein each of the plural circuit blocks has a fourth circuit that clamps a potential between the power supply voltage and the reference voltage of its own.
